(19) United States
(12) Patent Application Publication
(10) Pub. No.: US 2013/0183579 A1
(43) Pub. Date: Jul. 18, 2013

(54) POSITIVE ACTIVE MATERIAL FOR RECHARGEABLE LITHIUM BATTERY AND RECHARGEABLE LITHIUM BATTERY INCLUDING THE SAME

(71) Applicants: Seung-Mo Kim, Yongin-si (KR); Jun-Sik Jeoung, Yongin-si (KR)

(72) Inventors: Seung-Mo Kim, Yongin-si (KR); Jun-Sik Jeoung, Yongin-si (KR)

(21) Appl. No.: 13/560,954

(22) Filed: Jul. 27, 2012

Related U.S. Application Data
(60) Provisional application No. 61/587,505, filed on Jan. 17, 2012.

(51) Int. Cl. H01M 4/485; H01M 4/525; H01M 4/40; H01M 10/056; H01M 4/54; H01M 4/505; B82Y 30/00

(52) U.S. Cl. 429/206; 429/231.95; 429/219; 429/220; 429/221; 429/222; 429/223; 429/224; 429/231; 429/231.1; 429/231.2; 429/231.3; 977/742

(57) ABSTRACT

A positive active material for a rechargeable lithium battery includes a core including a lithium composite metal oxide selected from the group consisting of compounds represented by the following Chemical Formula 1, Chemical Formula 2, and combinations thereof; and a shell on the core, the shell including lithium iron phosphate (LiFePO₄), and the lithium iron phosphate being present in an amount in a range of about 5 to about 15 wt % based on the total weight of the positive active material.

LiₓMO₂ [Chemical Formula 1]

(wherein, in the above Chemical Formula 1, M is one or more transition elements, and 1≦x≦1.1)

yLi₂MnO₃·(1−y)LiM′O₂ [Chemical Formula 2]

(wherein, in the above Chemical Formula 2, M′ is one or more transition elements, and 0≦x≦1).

### CROSS-REFERENCE TO RELATED APPLICATION

This application claims priority to and the benefit of U.S. Provisional Application No. 61/587,505, filed on Jan. 17, 2012, in the United States Patent and Trademark Office, the entire content of which is incorporated herein by reference

### BACKGROUND

(a) Field

A positive active material for a rechargeable battery and a rechargeable lithium battery including the same are disclosed.

(b) Description of the Related Art

Recently, alternatives to the internal combustion engine have drawn attention over growing concerns of environmental contamination. The electric vehicle and hybrid electric vehicle may be considered as environmental-friendly technologies because they use electricity as a power source. However, the battery technology for storing electric energy should be further advanced in order to help commercialize the electric vehicle.

The rechargeable lithium battery, which is an energy storage device having high energy and power, is the subject of accelerated development due to its excellent merits of high capacity and driving voltage as compared to other batteries. However, due to its high energy characteristics, battery safety may be deteriorated and there may be concerns for explosion, fire or the like. Particularly, in the case of an electric vehicle using only an electric power source, a positive active material having a high energy density is used in order to improve the driving distance, but the stability of the battery is also weakened. Accordingly, the development of a positive active material providing improved driving distance and safety is a significant consideration in the development of batteries for electric vehicles.

In the case of a positive active material having a high energy density, the more lithium that is extracted from the positive electrode during the charge and intercalated into the negative electrode, the more that the positive electrode becomes structurally unstable, thereby causing internal and external short circuits and thermal runaway when there is overcharge or excessive heat exposure, and the concerns over explosion or fire from the battery are increased.

Olivine is a common material in the Earth, and it is cheap and has good structural stability. Although lithium iron phosphate (LiFePO₄) having olivine structure, which has been used for a rechargeable lithium battery, has advantages of safety and cost aspects, it also has relatively low voltage, capacity and cycle-life characteristics, so it is not widely applied to a positive electrode material for an electric automobile.

### SUMMARY

An aspect of an embodiment of the present invention is directed toward a positive active material for a rechargeable lithium battery having a high-capacity, excellent thermal stability, and excellent cycle characteristics at room temperature and at a high temperature, and a cycle-life characteristic capable of standing at a high temperature. Another aspect of an embodiment of the present invention is directed toward a rechargeable lithium battery including the same.

According to one embodiment of the present invention, a positive active material for a rechargeable lithium battery includes a core including a lithium composite metal oxide selected from the group consisting of compounds represented by the following Chemical Formula 1, Chemical Formula 2, and combinations thereof; and a shell on the core, the shell including lithium iron phosphate (LiFePO₄), and the lithium iron phosphate being present in an amount of about 5 to about 15 wt % based on the total amount of the positive active material.

LiₓMO₂ [Chemical Formula 1]

(wherein, in the above Chemical Formula 1, M is one or more transition elements, and 1≦x≦1.1)

yLi₂MnO₃·(1−y)LiM′O₂ [Chemical Formula 2]

(wherein, in the above Chemical Formula 2, M′ is one or more transition elements, and 0≦x≦1)

In one embodiment, M in Chemical Formula 1 and M′ in Chemical Formula 2 are each independently selected from the group consisting of NiₐCo_{b} (0≦a≦1, 0≦b≦1, a+b=1), CoₐMn_{b} (0<a<1, 0<b<1, a+b=1), NiₐMn_{b} (0<a<1, 0<b<1, a+b=1), NiₐCo_{b}Mn_{c} (0<a<1, 0<b<1, 0<c<1, a+b+c=1), NiₐCo_{b}Al_{c} (0<a<1, 0<b<1, 0<c<1, a+b+c=1), and combinations thereof.

The lithium composite metal oxide may have an average particle diameter in a range of about 6 to about 20 μm, and the lithium iron phosphate may have an average particle diameter in a range of about 0.2 to about 1 μm.

The lithium composite metal oxide may be doped or coated with a metal oxide selected from the group consisting of ZrO₂, Al₂O₃, MgO, TiO₂, and combinations thereof.

For example, the lithium composite metal oxide may be doped with a metal oxide selected from the group consisting of ZrO₂, Al₂O₃, MgO, TiO₂, and combinations thereof.

In one embodiment, the lithium composite metal oxide is coated with a metal oxide selected from the group consisting of ZrO₂, Al₂O₃, MgO, TiO₂, and combinations thereof, to form a second shell between the core and the shell.

The shell may further include a carbon-based material.

The carbon-based material may be selected from the group consisting of activated carbon, carbon black, including ketjen black and denka black, VGCF (vapor grown carbon fiber), carbon nanotubes, and combinations thereof.

The carbon-based material may be present in an amount in a range of about 0.5 to about 5 wt % based on the total weight of the positive active material.

In one embodiment, the core is present in an amount in a range of about 85 to about 95 wt % based on the total weight of the positive active material.

In one embodiment, the core includes the lithium composite metal oxide represented by Chemical Formula 1.

For example, the core may include the lithium composite metal oxide represented by Chemical Formula 1, and, in Chemical Formula 1, x=1. Additionally, the lithium iron phosphate may be present in the amount in the range of about 5 to about 10 wt % based on the total weight of the positive active material.

In one embodiment, the core includes the lithium composite metal oxide represented by Chemical Formula 1, and, in Chemical Formula 1, M is NiₐCo_{b}Mn_{c} (0<a<1, 0<b<1, 0<c<1, a+b+c=1). Additionally, in one embodiment 0.5≦a≦0.8.

According to another embodiment of the present invention, a lithium rechargeable battery includes a positive electrode including the positive active material, a negative electrode including a negative active material, and an electrolyte.

The negative active material may include a material selected from the group consisting of materials for reversibly intercalating and deintercalating lithium ions, lithium metal, lithium metal alloys, materials for doping and dedoping lithium, transition metal oxides, and combinations thereof.

The organic solvent may be selected from the group consisting of dimethyl carbonate (DMC), diethyl carbonate (DEC), dipropyl carbonate (DPC), methylpropyl carbonate (MPC), ethylpropyl carbonate (EPC), methylethyl carbonate (MEC), methyl propionate (MP), ethyl propionate (EP), ethylene carbonate (EC), propylene carbonate (PC), butylene carbonate (BC), and combinations thereof.

The lithium salt may be selected from the group consisting of LiPF₆, LiBF₄, LiBF₆, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (where, x and y are natural numbers), LiCl, LiI, LiB(C₂O₄)₂, and combinations thereof.

The electrolyte may further include phosphazenes or derivatives thereof.

The electrolyte may include phosphazenes or derivatives thereof in an amount in a range of about 5 to about 10 volume % based on the total amount of the electrolyte.

The electrolyte may further include a fluoro-substituted ether-based organic solvent, a fluoro-substituted carbonate-based organic solvent, or a combination thereof.

The electrolyte may include a fluoro-substituted ether-based organic solvent, a fluoro-substituted carbonate-based organic solvent, or a combination thereof in an amount in a range of about 5 to about 50 volume % based on the total amount of the electrolyte.

The positive active material for a rechargeable lithium battery according to one embodiment may have an excellent thermal stability even when overcharge or internal short circuit occurs.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a schematic cross-sectional view of the positive active material according to one embodiment of the present invention.

FIG. 1B is a schematic cross-sectional view of the positive active material according to another embodiment of the present invention.

FIG. 2 is an exploded cross-sectional view of a rechargeable lithium battery according to one embodiment of the present invention.

FIG. 3 is a pair of SEM photographs of a positive active material prepared according to Preparation Example 3.

FIG. 4 is a graph comparing the differential scanning calorimetry (DSC) of positive active materials prepared according to Preparation Example 1 and Comparative Preparation Example 4.

FIG. 5 is a graph comparing the differential scanning calorimetry (DSC) of positive active materials prepared according to Preparation Example 2 and Comparative Preparation Example 5.

FIG. 6 is a graph comparing the differential scanning calorimetry (DSC) of positive active materials prepared according to Preparation Example 3 and Comparative Preparation Example 1.

FIG. 7 is a graph comparing the differential scanning calorimetry (DSC) of positive active materials prepared according to Preparation Example 4 and Comparative Preparation Example 1.

FIG. 8 is a graph showing the differential scanning calorimetry (DSC) of positive active materials prepared according to Preparation Examples 5 to 7.

FIG. 9 is a graph showing the heat abuse evaluation of a lithium rechargeable battery cell prepared according to Example 3 by using an accelerating rate calorimeter (ARC).

FIG. 10 is a graph showing the heat abuse evaluation of a lithium rechargeable battery cell prepared according to Comparative Example 1 by using ARC.

FIG. 11 is a graph comparing the Heat-Wait-Seek evaluation of positive active materials prepared according to Example 3 and Comparative Example 1 by using ARC.

FIG. 12 is a graph showing overcharge evaluation of a rechargeable lithium battery cell prepared according to Example 3.

FIG. 13 is a graph showing the overcharge evaluation of a rechargeable lithium battery cell prepared according to Example 6.

FIG. 14 is a graph showing the overcharge evaluation of a rechargeable lithium battery cell prepared according to Comparative Example 1.

### DETAILED DESCRIPTION OF THE EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein.

In the drawings, the thickness of layers, films, panels, regions, etc., are exaggerated for clarity.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Like reference numerals designate like elements throughout the specification.

According to one embodiment of the present invention, the positive active material for a rechargeable lithium battery has a core-shell structure including a core and a shell, specifically a core including a lithium composite metal oxide selected from the group consisting of compounds represented by the following Chemical Formula 1, Chemical Formula 2, or combinations thereof; and a shell on the core, the shell including lithium iron phosphate (LiFePO₄), wherein the lithium iron phosphate is included (or present) in an amount of about 5 to about 15 wt % based on the total weight of the positive active material.

LiₓMO₂ [Chemical Formula 1]

(wherein, in the above Chemical Formula 1, M is one or more transition elements, and 1≦x≦1.1)

yLi₂MnO₃·(1−y)LiM′O₂ [Chemical Formula 2]

(wherein, in the above Chemical Formula 2, M′ is one or more transition elements, and 0≦x≦1)

In Chemical Formula 1, M is one or more transition elements, for example, in one embodiment, M is one or more metal(s) selected from the group consisting of Ni, Co, Mn, Mg, Fe, Cu, Zn, Cr, Ag, Ca, Na, K, In, Ga, Ge, V, Mo, Nb, Si, Ti, Zr, and combinations thereof.

The M may be a metal composite represented by NiₐCo_{b} (0≦a≦1, 0≦b≦1, a+b=1), CoₐMn_{b} (0<a<1, 0<b<1, a+b=1), NiₐMn_{b} (0<a<1, 0<b<1, a+b=1), NiₐCo_{b}Mn_{c} (0<a<1, 0<b<1, 0<c<1, a+b+c=1), NiₐCo_{b}Al_{c} (0<a<1, 0<b<1, 0<c<1, a+b+c=1), and the like. For example, M may be Ni, Ni_{1/3}Co_{1/3}Mn_{1/3}, Ni_{0.4}Co_{0.3}Mn_{0.3}, Ni_{0.5}Co_{0.2}Mn_{0.3}, Ni_{0.8}Co_{0.1}Mn_{0.1}, Ni_{0.75}Co_{0.1}Mn_{0.15}, Ni_{0.6}Co_{0.2}Mn_{0.2}, Ni_{0.08}Co_{0.15}Al_{0.05}, and the like.

In Chemical Formula 1, x is in the range of about 1 to about 1.1. When x is more than 1, a lithium metal composite oxide represented by the above Chemical Formula 1 may include excessive lithium. The lithium metal composite oxide represented by the above Chemical Formula 1 may be represented by, for example, Li_{1.02}Ni_{0.5}Co_{0.2}Mn_{0.3}O₂, Li_{1.08}Ni_{0.5}Co_{0.2}Mn_{0.3}O₂, Li_{1.1}Ni_{0.5}Co_{0.2}Mn_{0.3}O₂, Li_{1.1}Ni_{0.08}Co_{0.15}Al_{0.05}, and the like.

The lithium metal composite oxide represented by the above Chemical Formula 2 may be a solid solution where Li₂MnO₃ and LiM′O₂ exist in a solid solution state.

yLi₂MnO₃·(1−y)LiM′O₂ [Chemical Formula 2]

(wherein, in the above Chemical Formula 2, M′ is one or more transition elements, and 0≦x≦1)

When being present as a solid solution, the chemical stability of Mn of Li₂MnO₃ is improved so that Mn is inhibited from being eluted and degraded during repeating the charge and discharge, or such elution and degradation is reduced. Ultimately, the capacity deterioration is prevented or reduced.

In the lithium composite metal oxide of Chemical Formula 2, y represents the composition ratio of the solid Li₂MnO₃ and LiM′O₂, y may be in a range of 0 to 1, and y may be varied continuously within the range. For example, y may be in a range of 0.1 to 0.5.

In Chemical Formula 2, M′ is one or more transition elements, for example, in one embodiment, M′ is one or more metal(s) selected from the group consisting of Ni, Co, Mn, Mg, Fe, Cu, Zn, Cr, Ag, Ca, Na, K, In, Ga, Ge, V, Mo, Nb, Si, Ti, Zr, and combinations thereof. M′ may be a metal composite compound represented by NiₐCo_{b} (0<a<1, 0<b<1, a+b=1), CoₐMn_{b} (0<a<1, 0<b<1, a+b=1), NiₐMn_{b} (0<a<1, 0<b<1, a+b=1), NiₐCo_{b}Mn_{c} (0<a<1, 0<b<1, 0<c<1, a+b+c=1), NiₐCo_{b}Al_{c} (0<a<1, 0<b<1, 0<c<1, a+b+c=1), and the like. More particularly, the M′ may be represented by Ni_{1/3}Co_{1/3}Mn_{1/3}, Ni_{0.8}Co_{0.1}Mn_{0.1}, Ni_{0.5}Co_{0.2}Mn_{0.3}, Ni_{0.6}Co_{0.2}Mn_{0.2}, Ni_{0.08}Co_{0.15}Al_{0.05}, and the like.

In addition, Li₂MnO₃, which is a component of a lithium composite metal oxide of Chemical Formula 2, may have a layered structure; and the Mn component in Li₂MnO₃ may be substituted with other metal atoms. For example, in one embodiment, Mn in Li₂MnO₃ may be doped with an element selected from the group consisting of Al, Ga, Ge, Mg, Nb, Zn, Cd, Ti, Co, Ni, K, Na, Ca, Si, Fe, Cu, Sn, V, B, P, Se, Bi, As, Zr, Mn, Cr, Sr, V, Sc, Y, a rare earth element, and combinations thereof. When the Mn component is substituted with another element, the interlayer transport of the Mn component is suppressed, and, as a result, more lithium may be intercalated/deintercalated. Resultantly, the electric characteristics of the positive active material such as capacity characteristic or the like are improved.

The lithium composite metal oxide included in the core may have an average particle diameter in a range of about 6 to about 20 μm, for example, about 10 to about 15 μm. In addition, the lithium iron phosphate may have an average particle diameter in a range of about 0.2 to about 1 μm, for example, about 0.2 to about 0.5 μm. When the lithium composite metal oxide has an average particle diameter within the above range, and when the lithium iron phosphate has an average particle diameter within the above range, the lithium iron phosphate may have an excellent coating property to the surface of the lithium composite metal oxide, which is included in the core. On the other hand, when the average particle diameter of the lithium composite metal oxide is smaller than about 6 μm, and when the average particle diameter of the lithium iron phosphate is larger than about 1 μm, the composite metal oxide corresponding to the core deteriorates the efficiency of the surface coating process and its reproducibility.

The positive active material having the core-shell structure may be coated with a mixture that is prepared by mechanically mixing a combination of lithium iron phosphate and lithium composite metal oxide, including the compound represented by Chemical Formula 1, Chemical Formula 2 or a combination thereof, according to a dry mixing method, such as, for example, a mechanofusion method, on its surface, wherein the mechanical mixing process may be performed at a mixing speed in a range of about 8,000 to 1,2000 rpm for about 10 minutes to 120 minutes. When the surface of the positive active material is coated with lithium iron phosphate, heat is spontaneously generated inside the positive active material due to the high-speed agitation, so an additional heat treatment process is not required after the coating process. Accordingly, when the agitation speed and time are appropriately adjusted, the positive active material, including a shell of lithium iron phosphate, may be obtained with high reproducibility and efficiency without an additional heating treatment process. In contrast to methods that require a heating process after the coating process, a heat treatment process is not necessarily required by embodiments of the present invention, so the process time and cost of the process may be decreased.

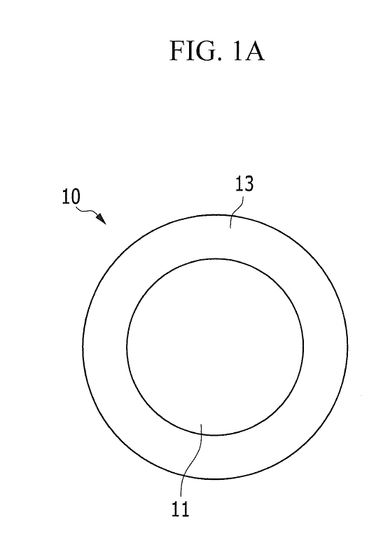

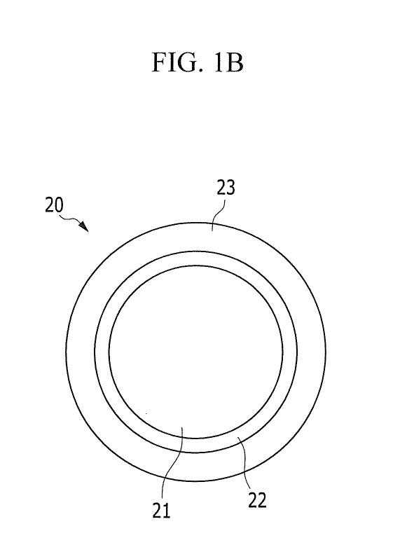

FIG. 1A is a cross-sectional view of the positive active material 10 according to one embodiment. In this embodiment, the positive active material 10 includes a core 11 including a lithium composite metal oxide and a shell 13 surrounding the core 11 and including a lithium iron phosphate.

Since the positive active material having the core-shell structure includes the shell of the thermally very stable lithium iron phosphate, the lithium composite metal oxide included in the core is prevented from directly contacting the electrolyte solution, or contact between the lithium composite metal oxide and the electrolyte solution is reduced, when overcharge, internal short circuit, exposure to heat at high temperature or the like occurs, thereby suppressing thermal runaway and combustion of the battery.

In addition, reaction of hydrogen fluoride (HF), which is a side product generated in the electrolyte, with the core of lithium composite metal oxide is suppressed, thereby resulting in substantial capacity of a battery, so that the cycle-life characteristic of the battery is improved. Furthermore, since the exothermic production of heat increases in proportion to the increase of the specific capacity of conventional positive active materials, it is difficult to include conventional active materials in high capacity batteries such as those used for electric vehicles. On the other hand, according to embodiments of the present invention, the positive active material having the core-shell structure may provide thermal stability due to the presence of the shell, as well as providing high capacity (e.g., by being capable of including an excessive amount of Ni) due to the lithium composite metal oxide included in the core.

In the core-shell structure according to one embodiment, the shell may be included in an amount in a range of about 5 to about 15 wt %, for example, about 5 to about 10 wt %, based on the total amount of the positive active material. The term ‘total amount of the positive active material’ refers to the total weight including the core and the shell. When the shell is included within the above numerical range, the rechargeable lithium battery may have excellent thermal stability, cycle-life characteristics and a high-capacity. However, in one embodiment, when the shell is included in an amount of more than about 15 wt %, the high-capacity positive active material is not accomplished (e.g., the resulting positive active material does not have high capacity); and, in another embodiment, when the shell is included in an amount of less than about 5 wt %, the reaction between the core and the electrolyte is not sufficiently suppressed, so the thermal safety characteristics of the positive active material are not improved.

In addition, the shell may have a thickness in a range of 0.5 to 1.5 μm, for example, 0.8 to 1 μm. When the content and the thickness of the shell satisfy the above numerical ranges, the positive active material has excellent thermal safety, since the surface of the core of lithium composite metal oxide is sufficiently coated.

Additionally, in one embodiment the shell including lithium iron phosphate may further include a carbon-based material.

The carbon-based material may be activated carbon having high specific area, carbon black, including ketjen black, or denka black, VGCF (vapor grown carbon fiber), carbon nanotube, a combination thereof, or the like. When further including the carbon-based material in a shell, the electric conductivity of lithium iron phosphate may be improved, so the high rate characteristics and cycle characteristics of rechargeable lithium battery are improved.

The carbon-based material may be included in an amount in a range of about 0.5 to about 5 wt %, for example, 1 to 3 wt %, based on the total weight of the positive active material. In addition, as the specific surface area of the carbon-based material increases, a smaller amount of the carbon-based material may be used to improve the performance of the positive active material, so it is further advantageous when the specific surface of the carbon-based material included in the shell is increased. Accordingly, the carbon-based material may have an average particle diameter in a range of about 20 to 60 nm, for example, 30 to 40 nm. When the carbon-based material has an average particle diameter within the above numerical range, the carbon-based material has excellent coating properties for coating the surface of the core of the lithium composite metal oxide, and the conductivity of the positive active material is improved.

According to another embodiment of the present invention, the positive active material includes a core including a lithium composite metal oxide; a first shell including a metal oxide doped or coated on the surface of the core, wherein the metal oxide may be selected from the group consisting of ZrO₂, Al₂O₃, MgO, TiO₂, and combinations thereof; and a second shell including lithium iron phosphate coated on the surface of the first shell. For example, in one embodiment, the first shell is between the core and the second shell. According to one embodiment, the positive active material may be obtained by dry-coating lithium iron phosphate on the core positive active material in which lithium composite metal oxide is doped or coated with a metal oxide selected from the group consisting of ZrO₂, Al₂O₃, MgO, TiO₂, and combinations thereof.

Relating to the above, FIG. 1 B is a schematic cross-sectional view showing the positive active material 20 according to one embodiment. The positive active material 20 includes a first shell 22 in which at least one metal oxide selected from the group consisting of ZrO₂, Al₂O₃, MgO, TiO₂, and combinations thereof is doped or coated on the core 21, which includes lithium composite metal oxide; and a second shell 23 in which lithium iron phosphate is coated on the surface of the first shell.

The first shell 22 including the metal oxide may be obtained by coating the core 21 by way of a sieving process with a precursor including the metal of the metal oxide and heating the same, or mixing together a metal oxide 22 precursor and the core 21 during a precursor period and firing the resultant mixture. The coating process may be performed according to any suitable method as long as it does not detrimentally affect the physical properties of the core. For example, the coating process may include spraying coating, dipping or the like, without limitation, each of which are well understood by persons of ordinary skill in the art, so further detailed description thereof will be omitted.

As described above, the positive active material including the first shell and the second shell on the surface of lithium composite metal oxide may effectively suppress or reduce contact between the core and impurities, such as hydrogen fluoride, generated in the electrolyte solution during the charge and discharge, and may prevent or reduce the capacity deterioration of the rechargeable lithium battery.

According to yet another embodiment of the present invention, a rechargeable lithium battery includes a positive electrode including the positive active material, a negative electrode including a negative active material and facing the positive electrode, and an electrolyte including an organic solvent and a lithium salt between the positive electrode and the negative electrode.

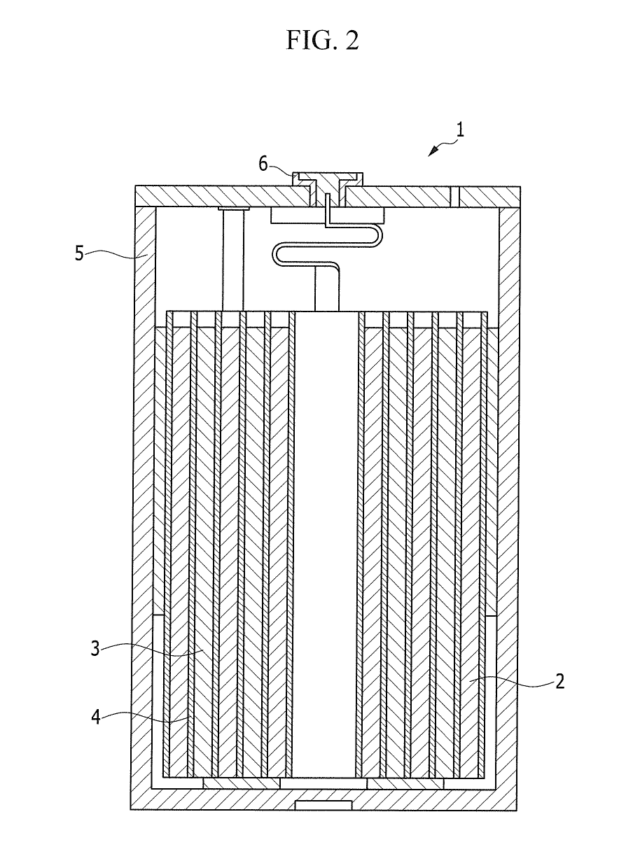

The rechargeable lithium battery may be classified as a lithium ion battery, a lithium ion polymer battery, or a lithium polymer battery according to the presence of a separator and the kind of electrolyte used therein. The rechargeable lithium battery may have a variety of shapes and sizes and thus, may be a cylindrical, prismatic, coin, or pouch-shape battery; and be a thin film battery or a bulky battery in size. The structure and methods of fabricating a lithium ion battery pertaining to the present invention are well known in the art. The schematic structure of the rechargeable lithium battery of an embodiment of the present invention is illustrated in FIG. 2. As shown in FIG. 2, the rechargeable lithium battery 1 includes a battery case including a negative electrode 3, a positive electrode 2, and an electrolyte impregnated in a separator 4 interposed between the negative electrode 3 and the positive electrode 2, and a cap plate 6 sealing the battery case 5.

The positive electrode may include a current collector and a positive active material layer disposed on the current collector, and the current collector may include the positive active material on one side or both sides thereof. The positive active material is the same as described above.

The positive active material layer may include a binder and a conductive material.

The binder improves binding properties of the positive active material particles to each other and to a current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of the negative electrode. Any electrically conductive material can be used as a conductive agent unless it causes a chemical change. Examples of the conductive material include at least one selected from the group consisting of natural graphite, artificial graphite, carbon black, acetylene black, ketjen black, a carbon fiber, metal powder, a metal fiber of copper, nickel, aluminum, silver, and the like, and a polyphenylene derivative.

The current collector may be aluminum (Al), but it is not limited thereto.

The negative electrode includes a current collector and a negative active material layer disposed on the current collector. The negative active material layer may include a negative active material.

The negative active material may include a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions includes carbon materials which are any suitable carbon-based negative active materials generally-used in a lithium ion rechargeable battery. Examples of the carbon-based negative active material include crystalline carbon, amorphous carbon or a mixture thereof. The crystalline carbon may be non-shaped, or sheet, flake, spherical, or fiber shaped natural graphite or artificial graphite. The amorphous carbon may be a soft carbon, a hard carbon, a mesophase pitch carbonized product, fired coke, or the like.

The lithium metal alloy include lithium and a metal of Na, K, Rb, Cs, Fr, Be, Mg, Ca, Sr, Si, Sb, Pb, In, Zn, Ba, Ra, Ge, Al, or Sn.

The material being capable of doping and dedoping lithium may include Si, SiOₓ (0<x<2), a Si-Q alloy (wherein Q is an alkali metal, an alkaline-earth metal, group 13 to 16 elements, a transition element, a rare earth element, or a combination thereof, and not Si), Sn, SnO₂, a Sn—R alloy (wherein R is an alkali metal, an alkaline-earth metal, group 13 to 16 elements, a transition element, a rare earth element, or a combination thereof, and not Sn), or the like. At least one of these materials may be mixed with SiO₂. The elements Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, and the like.

The negative active material layer includes a binder, and, optionally, a conductive material.

The binder improves binding properties of negative active material particles with one another and with the current collector. Examples of the binder include polyvinylalcohol, carboxylmethylcellulose, hydroxypropylcellulose, polyvinylchloride, carboxylated polyvinylchloride, polyvinylfluoride, an ethylene oxide-containing polymer, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of a negative electrode. Any electrically conductive material can be used as a conductive agent, unless it causes a chemical change. Examples of the conductive material include a carbon-based material such as natural graphite, artificial graphite, carbon black, acetylene black, ketjen black, a carbon fiber, or the like; a metal-based material of a metal powder or a metal fiber including copper, nickel, aluminum, silver, or the like; a conductive polymer such as a polyphenylene derivative, or the like; or a combination thereof.

The current collector includes a copper foil, a nickel foil, a stainless steel foil, a titanium foil, a nickel foam, a copper foam, a polymer substrate coated with a conductive metal, or a combination thereof.

The negative and positive electrodes may be fabricated in a method of preparing an active material composition by mixing the active material, a conductive material, and a binder and coating the composition on a current collector. The electrode manufacturing method is well known and thus, is not described in detail in the present specification. In one embodiment, the solvent includes N-methylpyrrolidone and the like but it is not limited thereto.

The electrolyte may include a non-aqueous organic solvent and a lithium salt.

The non-aqueous organic solvent plays a role of transmitting ions taking part in the electrochemical reaction of a battery.

The non-aqueous organic solvent may include a carbonate-based, ester-based, ether-based, ketone-based, alcohol-based, or aprotic solvent, but it is not limited thereto. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester-based solvent may include methyl acetate, ethyl acetate, n-propyl acetate, dimethylacetate, methylpropionate, ethylpropionate, Γ-butyrolactone, decanolide, valerolactone, mevalonolactone, caprolactone, or the like. The ether-based solvent may include dibutyl ether, tetraglyme, diglyme, dimethoxyethane, 2-methyltetrahydrofuran, tetrahydrofuran, or the like. The ketone-based solvent may include cyclohexanone, or the like. The alcohol-based solvent may include ethanol, isopropyl alcohol, or the like. The aprotic solvent may include nitriles such as R—CN (wherein R is a C2 to C20 linear, branched, or cyclic hydrocarbon group, and may include a double bond, an aromatic ring, or an ether bond), amides such as dimethylformamide, dimethylacetamide, dioxolanes such as 1,3-dioxolane, sulfolanes, or the like.

The electrolyte may further include a fluoro-substituted ether-based organic solvent, a fluoro-substituted carbonate-based organic solvent, or a combination thereof. In particular, the electrolyte may include 5 to 50 volume % of the fluoro-substituted ether-based organic solvent, fluoro-substituted carbonate-based organic solvent, or a combination thereof based on the total volume of the electrolyte.

The non-aqueous organic solvent may be used singularly or in a mixture. When the organic solvent is used in a mixture, its mixture ratio can be controlled in accordance with desirable performance of a battery.

The carbonate-based solvent may include a mixture of a cyclic carbonate and a linear carbonate. In one embodiment, the cyclic carbonate and the linear carbonate are mixed together in a volume ratio of about 1:1 to about 1:9 as an electrolyte. Within the above numerical range, the electrolyte may have enhanced performance.

For example, the cyclic carbonate and linear carbonate may be mixed together in a volume ratio in a range of about 2:8 to about 3:7.

The non-aqueous organic solvent may further include an aromatic hydrocarbon-based organic solvent along with the carbonate-based solvent. In one embodiment, the aromatic hydrocarbon-based organic solvent and carbonate-based organic solvent may be used in a weight ratio in a range of about 0.5:95.5 to 3:97.

The aromatic hydrocarbon-based organic solvent may be an aromatic hydrocarbon-based compound represented by the following Chemical Formula 3.

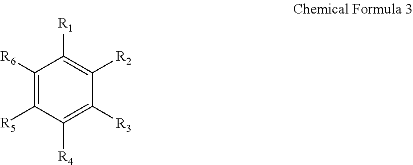

In the above Chemical Formula 3, R¹ to R⁶ are independently selected from hydrogen, a halogen, a C1to C10 alkyl group, a C1to C10 haloalkyl group, or a combination thereof.

The aromatic hydrocarbon-based organic solvent may be benzene, flourobenzene, 1,2-difluorobenzene, 1,3-difluorobenzene, 1,4-difluorobenzene, 1,2,3-trifluorobenzene, 1,2,4-trifluorobenzene, cholorobenzene, 1,2-dicholorobenzene, 1,3-dicholorobenzene, 1,4-dicholorobenzene, 1,2,3-tricholorobenzene, 1,2,4-tricholorobenzene, iodobenzene, 1,2-diiodobenzene, 1,3-diiodobenzene, 1,4-diiodobenzene, 1,2,3-triiodobenzene, 1,2,4-triiodobenzene, toluene, flourotoluene, 1,2-diflourotoluene, 1,3-diflourotoluene, 1,4-diflourotoluene, 1,2,3-triflourotoluene, 1,2,4-triflourotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a mixture thereof.

The lithium salt is dissolved in the non-aqueous solvent and supplies lithium ions in a rechargeable lithium battery, and basically operates the rechargeable lithium battery and improves lithium ion transfer between positive and negative electrodes. The lithium salt include at least one supporting salt selected from the group consisting of LiPF₆, LiBF₄, LiBF₆, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (x and y are natural number), LiCl, LiI, LiB(C₂O₄)₂ (lithium bis(oxalato)borate, LiBOB), and a combination thereof. The lithium salt may have a concentration in a range of 0.1 to 2.0 M. In one embodiment, when the lithium salt is included within the above concentration range, the electrolyte may have appropriate conductivity and viscosity to provide excellent electrolyte performance and excellent lithium ion mobility.

The rechargeable lithium battery may further include a separator between the negative electrode and the positive electrode according to the kind of rechargeable lithium battery. The separator may be formed of polyethylene, polypropylene, polyvinylidene fluoride or multi-layers thereof such as a polyethylene/polypropylene double-layered separator, a polyethylene/polypropylene/polyethylene triple-layered separator, or a polypropylene/polyethylene/polypropylene triple-layered separator. The separator may be a separator coated with a ceramic layer such as Al₂O₃, and the like.

The following examples illustrate the present invention in more detail. These examples, however, should not in any sense be interpreted as limiting the scope of the present invention.

### PREPARATION EXAMPLE 1

### (Preparation of Positive Active Material)

LiNi_{0.8}Co_{0.1}Mn_{0.1}O₂ having an average particle diameter (D50) of 13.7 μm and lithium iron phosphate having an average particle diameter of 1 μm were prepared, and the prepared LiNi_{0.8}Co_{0.1}Mn_{0.1}O₂ and lithium iron phosphate were introduced into a mechanofusion apparatus in amounts of 900 g and 100 g, respectively, to provide 90 wt % of a core and 10 wt % of a shell based on 100 wt % of the positive active material. Thereafter, the mechanofusion apparatus was operated at 10,000 rpm for 60 minutes to coat the lithium iron phosphate on the surface of LiNi_{0.8}Co_{0.1}Mn_{0.1}O₂.

Due to the particle diameter difference between the lithium composite oxide and the lithium iron phosphate for the core and the shell, particles of lithium iron phosphate were coated on the surface of the core during the high-speed rotation. Thereby, a positive active material including a shell having a thickness of 1 μm was obtained.

### PREPARATION EXAMPLE 2

A positive active material having a core-shell structure was prepared in accordance with the same procedure as in Preparation Example 1, except that LiNi_{0.8}Co_{0.15}Al_{0.05}O₂ having an average particle diameter of 7 μm was used.

### PREPARATION EXAMPLE 3

A positive active material having a core-shell structure was prepared in accordance with the same procedure as in Preparation Example 1, except that LiNi_{0.5}Co_{0.2}Mn_{0.3}O₂ having an average particle diameter of 10 μm was used.

### PREPARATION EXAMPLE 4

A positive active material having a core-shell structure was prepared in accordance with the same procedure as in Preparation Example 1, except that LiNi_{0.5}Co_{0.2}Mn_{0.3}O₂ having an average particle diameter of 10 μm was used and coated to provide a positive active material having a core and a shell in amounts of 95 wt % and 5 wt %, respectively, based on 100 wt % of the positive active material.

### PREPARATION EXAMPLE 5

LiNi_{0.5}Co_{0.2}Mn_{0.3}O₂ having an average particle diameter of 10 μm, lithium iron phosphate having an average particle diameter of 1 μm, and denka black having an average particle diameter of 40 nm were prepared.

Based on the total weight of the positive active material, 89 wt % of LiNi_{0.5}Co_{0.2}Mn_{0.3}O₂, 10 wt % of lithium iron phosphate, and 1 wt % of denka black were introduced in a mechanofusion apparatus and rotated at 10,000 rpm for 60 minutes to coat lithium iron phosphate on the surface of LiNi_{0.5}Co_{0.2}Mn_{0.3}O₂.

### PREPARATION EXAMPLE 6

LiNi_{0.5}Co_{0.2}Mn_{0.3}O₂ having an average particle diameter of 10 μm, lithium iron phosphate having an average particle diameter of 1 μm, and denka black having an average particle diameter of 40 nm were prepared.

Based on the total weight of the positive active material, 87 wt % of LiNi_{0.5}Co_{0.2}Mn_{0.3}O₂, 10 wt % of lithium iron phosphate, and 3 wt % of denka black were introduced into a mechanofusion apparatus and rotated at 10,000 rpm for 60 minutes to coat the surface of LiNi_{0.5}Co_{0.2}Mn_{0.3}O₂with lithium iron phosphate.

### PREPARATION EXAMPLE 7

LiNi_{0.5}Co_{0.2}Mn_{0.3}O₂ having an average particle diameter of 10 μm, lithium iron phosphate having an average particle diameter of 1 μm, and denka black having an average particle diameter of 40 nm were prepared.

Based on the total weight of the positive active material, 85 wt % of LiNi_{0.5}Co_{0.2}Mn_{0.3}O₂, 10 wt % of lithium iron phosphate, and 5 wt % of denka black were introduced into a mechanofusion apparatus and rotated at 10,000 rpm for 60 minutes to coat the surface of LiNi_{0.5}Co_{0.2}Mn_{0.3}O₂ with lithium iron phosphate.

### PREPARATION EXAMPLE 8

LiNi_{0.5}Co_{0.2}Mn_{0.3}O₂ having an average particle diameter of 10 μm and lithium iron phosphate having an average particle diameter of 1 μm were prepared.

Based on the total weight of the positive active material, 85 wt % of LiNi_{0.5}Co_{0.2}Mn_{0.3}O₂ and 15 wt % of lithium iron phosphate were introduced into a mechanofusion apparatus and rotated at 10,000 rpm for 60 minutes to coat the surface of LiNi_{0.5}Co_{0.2}Mn_{0.3}O₂ with lithium iron phosphate.

### PREPARATION EXAMPLE 9

0.1Li₂MnO₃.0.9LiNi_{0.4}Co_{0.2}Mn_{0.4}O₂ having an average particle diameter of 11.8 μm and lithium iron phosphate having an average particle diameter of 1 μm, were prepared. The prepared 0.1Li₂MnO₃.0.9LiNi_{0.4}Co_{0.2}Mn_{0.4}O₂ and lithium iron phosphate were introduced into a mechanofusion apparatus in weight of, 90 wt % and 10 wt %, respectively, and rotated at 10,000 rpm for 60 minutes to coat the surface of 0.1Li₂MnO₃.0.9LiNi_{0.4}Co_{0.2}Mn_{0.4}O₂ with lithium iron phosphate.

### PREPARATION EXAMPLE 10

0.1Li₂MnO₃.0.9LiNi_{0.4}Co_{0.2}Mn_{0.4}O₂ having an average particle diameter of 11.8 μm and lithium iron phosphate having an average particle diameter of 1 μm, were prepared. The prepared 0.1Li₂MnO₃.0.9LiNi_{0.4}Co_{0.2}Mn_{0.4}O₂ and lithium iron phosphate were introduced into a mechanofusion apparatus in weight of, 85 wt % and 15 wt %, respectively, and rotated at 10,000 rpm for 60 minutes to coat the surface of 0.1Li₂MnO₃.0.9LiNi_{0.4}Co_{0.2}Mn_{0.4}O₂ with lithium iron phosphate.

### COMPARATIVE PREPARATION EXAMPLE 1

LiNi_{0.5}Co_{0.2}Mn_{0.3}O₂ not having a shell according to embodiments of the invention on its surface was used for a positive active material. The positive active material had an average particle diameter of 10 μm.

### COMPARATIVE PREPARATION EXAMPLE 2

A positive active material was prepared in accordance with the same procedure as in Preparation Example 1, except that the core and the shell were present in amounts of 98 wt % and 2 wt %, respectively, based on 100 wt % of positive active material.

### COMPARATIVE PREPARATION EXAMPLE 3

A positive active material was prepared in accordance with the same procedure as in Preparation Example 1, except that the core and the shell were provided in amounts of 83 wt % and 17 wt %, respectively, based on 100 wt % of positive active material.

### COMPARATIVE PREPARATION EXAMPLE 4

As a positive active material, LiNi_{0.8}Co_{0.1}Mn_{0.1}O₂ not having a shell according to embodiments of the invention on its surface was prepared.

### COMPARATIVE PREPARATION EXAMPLE 5

As a positive active material, LiNi_{0.8}Co_{0.15}Al_{0.05}O₂ not having a shell according to embodiments of the invention on its surface was prepared.

### COMPARATIVE PREPARATION EXAMPLE 6

As a positive active material, −0.1Li₂MnO₃.0.9LiNi_{0.4}Co_{0.2}Mn_{0.4}O₂ not having a shell according to embodiments of the invention on its surface was prepared.

### COMPARATIVE PREPARATION EXAMPLE 7

A positive active material having a core-shell structure was prepared in accordance with the same procedure as in Preparation Example 1, except that 0.1Li₂MnO₃.0.9LiNi_{0.4}Co_{0.2}Mn_{0.4}O₂ having an average particle diameter of 11.8 μm was used and coated with lithium iron phosphate having an average particle diameter of 1 μm, were prepared, wherein the core and the shell were present in amounts of 98 wt % and 2 wt %, respectively, based on 100 wt % of positive active material.

The following Table 1 shows the composition and average particle diameter of positive active materials prepared according to Preparation Examples 1 to 10 and Comparative Preparation Examples 1 to 7.

TABLE 1

| | | | Shell (wt %) | | D50 (μm) | | |
|---|---|---|---|---|---|---|---|
| | | | Lithium | | | | Carbon- |
| | Core | | iron | | | | based |
| | Composition | wt % | phosphate | Carbon | Core | Shell | material |
| Preparation | LiNi_{0.8}Co_{0.1}Mn_{0.1}O₂ | 90 | 10 | | 13.7 | 1 | — |
| Example 1 | | | | | | | |
| Preparation | LiNi_{0.8}Co_{0.15}Al_{0.05}O₂ | 90 | 10 | — | 7 | 1 | — |
| Example 2 | | | | | | | |
| Preparation | LiNi_{0.5}Co_{0.2}Mn_{0.3}O₂ | 90 | 10 | — | 10 | 1 | — |
| Example 3 | | | | | | | |
| Preparation | LiNi_{0.5}Co_{0.2}Mn_{0.3}O₂ | 95 | 5 | — | 10 | 1 | — |
| Example 4 | | | | | | | |
| Preparation | LiNi_{0.5}Co_{0.2}Mn_{0.3}O₂ | 89 | 10 | 1 | 10 | 1 | 0.04 |
| Example 5 | | | | | | | |
| Preparation | LiNi_{0.5}Co_{0.2}Mn_{0.3}O₂ | 87 | 10 | 3 | 10 | 1 | 0.04 |
| Example 6 | | | | | | | |
| Preparation | LiNi_{0.5}Co_{0.2}Mn_{0.3}O₂ | 85 | 10 | 5 | 10 | 1 | 0.04 |
| Example 7 | | | | | | | |
| Preparation | LiNi_{0.5}Co_{0.2}Mn_{0.3}O₂ | 85 | 15 | — | 10 | 1 | — |
| Example 8 | | | | | | | |
| Preparation | 0.1Li₂MnO₃•0.9LiNi_{0.4} | 90 | 10 | — | 11.8 | 1 | — |
| Example 9 | Co_{0.2}Mn_{0.4}O₂ | | | | | | |
| Preparation | 0.1Li₂MnO₃•0.9LiNi_{0.4} | 85 | 15 | — | 11.8 | 1 | — |
| Example 10 | Co_{0.2}Mn_{0.4}O₂ | | | | | | |
| Comparative | LiNi_{0.5}Co_{0.2}Mn_{0.3}O₂ | 100 | — | — | 10 | — | — |
| Preparation | | | | | | | |
| Example 1 | | | | | | | |
| Comparative | LiNi_{0.5}Co_{0.2}Mn_{0.3}O₂ | 98 | 2 | — | 10 | — | — |
| Preparation | | | | | | | |
| Example 2 | | | | | | | |
| Comparative | LiNi_{0.5}Co_{0.2}Mn_{0.3}O₂ | 83 | 17 | — | 10 | — | — |
| Preparation | | | | | | | |
| Example 3 | | | | | | | |
| Comparative | LiNi_{0.8}Co_{0.1}Mn_{0.1}O₂ | 100 | — | — | 13.7 | — | — |
| Preparation | | | | | | | |
| Example 4 | | | | | | | |
| Comparative | LiNi_{0.8}Co_{0.15}Al_{0.05}O₂ | 100 | — | — | 7 | — | — |
| Preparation | | | | | | | |
| Example 5 | | | | | | | |
| Comparative | 0.1Li₂MnO₃•0.9LiNi_{0.4} | 100 | — | — | 11.8 | — | — |
| Preparation | Co_{0.2}Mn_{0.4}O₂ | | | | | | |
| Example 6 | | | | | | | |
| Comparative | 0.1Li₂MnO₃•0.9LiNi_{0.4} | 98 | 2 | — | 11.8 | 1 | — |
| Preparation | Co_{0.2}Mn_{0.4}O₂ | | | | | | |
| Example 7 | | | | | | | |

SEM Photograph of Positive Active Material

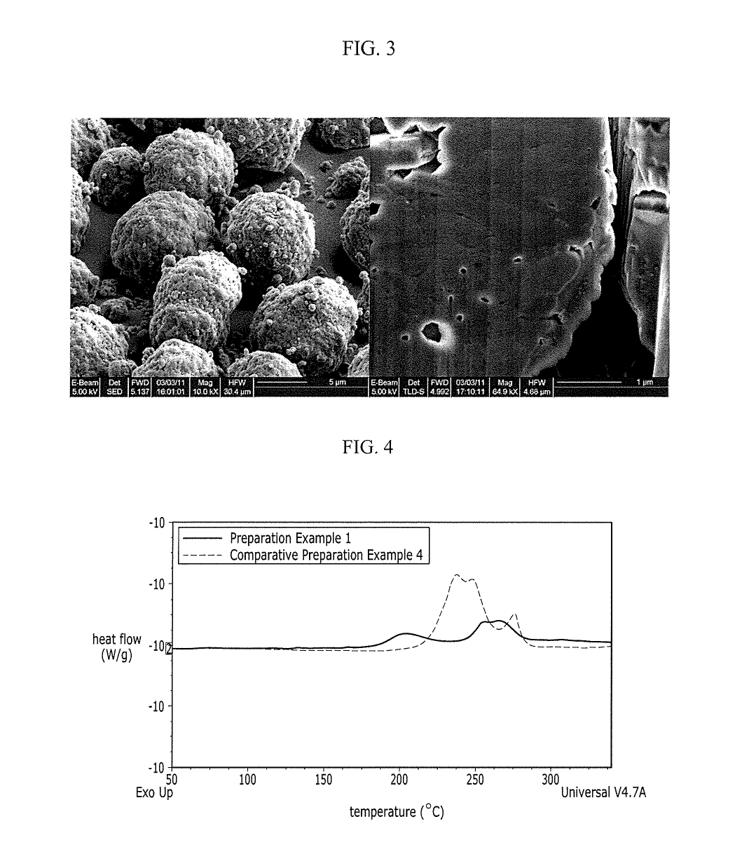

FIG. 3 is a pair of SEM photographs of a positive active material prepared according to Preparation Example 3. While the coating process was performed using mechanofusion in a high-speed dry mixing method, as shown in FIG. 3, protrusions and depressions were appropriately produced when the first particle of lithium metal composite oxide was agglomerated to provide a second particle, such that the lithium iron phosphate was coated between the protrusions and depressions. Preparation Examples 1 to 7 provided positive active materials including a lithium iron phosphate shell by adjusting the particle size and the content ratio of lithium composite metal oxide and lithium iron phosphate in the core.

### EXAMPLES 1 TO 7 AND COMPARATIVE EXAMPLES 1 TO 3

### (Fabrication of Rechargeable Lithium Battery Cell)

Each positive active material obtained from Preparation Examples 1 to 7 and Comparative Preparation Examples 1 to 3, a conductive material of Denka black, and a binder of PVDF were prepared, and the positive active material, the Denka black and the binder were mixed in a solvent of N-methyl pyrrolidone at a weight ratio of 92:4:4, respectively, to provide a positive electrode slurry. The slurry was coated on Al foil, dried, and compressed to a thickness of 131 μm to provide a positive electrode. In addition, a negative active material of artificial graphite, a binder of styrene butadiene rubber (SBR), and a thickener of carboxymethyl cellulose (CMC) were mixed at a weight ratio of 98:1:1, respectively, to provide a negative electrode slurry and coated on a Cu foil, dried, and compressed to provide a negative electrode.

The positive electrode and the negative electrode were wound interposing a polypropylene/polyethylene/polypropylene separator between the negative electrode and the positive electrode to provide a rechargeable lithium battery cell. An electrolyte was prepared by mixing 1.3M of LiPF₆ and a mixed organic solvent of ethylene carbonate (EC), ethylmethyl carbonate (EMC), and dimethyl carbonate(DC) at a volume ratio of 3:4:3, respectively.

Electrochemical Characteristic and Thermal Stability

The rechargeable lithium battery cells obtained from Examples 1 to 7 and Comparative Examples 1 to 3 were measured for a capacity retention when allowed to stand at a high temperature of 60° C. and a capacity retention at 45° C. after 300 cycles.

### (1) Evaluation of Capacity Retention (%) After Allowed to Stand at High Temperature (60° C.)

The battery cells obtained from Examples 1 to 7 and Comparative Examples 1 to 3 were charged to 4.2 V at SOC (state of charge) of 100% and allowed to stand in a high temperature chamber of 60° C. for 30 days, and then discharged at 0.2 C current density to 2.8 V and constant current-constant voltage (CC-CV) charged at 0.5 C current density to 4.2 V and discharged at 0.2 C current density to 2.8 V to determine a discharge capacity. Then according to Equation 1, the battery cells were allowed to stand at a high temperature (60° C.) for 30 days to determine a capacity retention.

Capacity retention after being allowed to stand at high temperature (%)=(discharge capacity after being allowed to stand at high temperature/initial discharge capacity)×100 Equation 1:

### (2) Capacity Retention (%) After 300 Cycles at 45° C.

The battery cell was introduced into a thermostat chamber of 45° C. and charged and discharged for 300 cycles at 2.8 V-4.2 V voltage range under 1 C/1 C current condition, and then CC-CV charged to 4.2 V at 1 C current density and discharged until 2.8 V at 0.2 C current density to determine a discharge capacity. Then the capacity retention was evaluated according to Equation 2.

Capacity retention after 300 cycles (%)=(300^{th} discharge capacity/initial discharge capacity)×100 Equation 2:

### (3) Thermal Stability Evaluation 1: DSC

About 2 g of each positive active material obtained from Preparation Examples 1 to 7 and Comparative Preparation Examples 1 to 3 was measured for the calorie change using a differential scanning calorimetry (DSC: differential scanning calorimetry) instrument (Q2000 of TA instruments). First, the battery cells obtained from Preparation Examples 1 to 7 and Comparative Preparation Examples 1 to 3 were charged at 100% at 0.2 C to 4.2 V, and the battery cells were disassembled. The positive electrode plate was cleaned by DMC (dimethyl carbonate), and the positive electrode was sampled in the same size to measure the positive electrode weight. The positive electrode was introduced into an electrolyte solution in a weight ratio of 1:0.87, and the DSC was evaluated. The calorie change was monitored from 50° C., which is a starting point, to 400° C., and the calculated exothermic heat (the value obtained when the exothermal curved line in DSC is integrated by temperature), the on-set temperature, and the exothermic temperature were as shown in the following Table 2.

The test results are shown in the following Table 2.

TABLE 2

| | | Capacity | | | |
|---|---|---|---|---|---|
| | | retention | | | |
| | | after being | | | |
| | 300 | allowed to | DSC | | |
| | cycle | stand at | | On-set | Peak |
| | capacity | high | | temper- | temper- |
| | retention | temperature | Exothermic | ature | ature |
| | (%) | (60° C.) (%) | heat (J/g) | (° C.) | (° C.) |
| Preparation | 63% | 89% | 987 | 242 | 269 |
| Example 1 | | | | | |
| Preparation | 72% | 91% | 992 | 189 | 315 |
| Example 2 | | | | | |
| Preparation | 91% | 91% | 957 | 332 | 339 |
| Example 3 | | | | | |
| Preparation | 95% | 94% | 1110 | 247 | 271 |
| Example 4 | | | | | |
| Preparation | 97% | 98% | 652 | 239 | 258 |
| Example 5 | | | | | |
| Preparation | 98% | 97% | 203 | 258 | 278 |
| Example 6 | | | | | |
| Preparation | 93% | 90% | 460 | 256 | 278 |
| Example 7 | | | | | |
| Preparation | 93% | 91% | 1005 | 262 | 280 |
| Example 8 | | | | | |
| Preparation | 95% | 92% | 642 | 252 | 263 |
| Example 9 | | | | | |
| Preparation | 92% | 91% | 983 | 240 | 250 |
| Example 10 | | | | | |
| Comparative | 89% | 90% | 1323 | 298 | 307 |
| Preparation | | | | | |
| Example 1 | | | | | |
| Comparative | 90% | 91% | 1257 | 298 | 312 |
| Preparation | | | | | |
| Example 2 | | | | | |
| Comparative | 92% | 89% | 1111 | 252 | 266 |
| Preparation | | | | | |
| Example 3 | | | | | |
| Comparative | 55% | 84% | 1630 | 220 | 238 |
| Preparation | | | | | |
| Example 4 | | | | | |
| Comparative | 65% | 90% | 1520 | 241 | 250 |
| Preparation | | | | | |
| Example 5 | | | | | |
| Comparative | 90% | 91% | 1136 | 236 | 248 |
| Preparation | | | | | |
| Example 6 | | | | | |
| Comparative | 90% | 90% | 1102 | 234 | 247 |
| Preparation | | | | | |
| Example 7 | | | | | |

As shown in Table 2, Preparation Examples 1 to 7 coated with a shell including lithium iron phosphate, according to embodiments of the invention, had remarkably lower exothermic heat as compared to Comparative Preparation Examples 1 to 5. Particularly, Preparation Examples 3 to 7 had exothermic heats of 957 J/g, 1110 J/g, 652 J/g, 203 J/g, 460 J/g, respectively, which were remarkably lower than Comparative Preparation Examples 1 to 3, which include the same lithium composite metal. As such, the reaction between the electrolyte solution and the lithium composite metal oxide was suppressed by the lithium iron phosphate coating the cores of Examples 3 to 7, so as to improve the thermal stability of the rechargeable lithium battery cell. However, Comparative Examples 2 and 3 including lithium iron phosphate as a shell in 2 wt % and 17 wt %, respectively, based on the total amount of positive active material, barely improved the exothermic heat as compared to Comparative Example 1. In addition, Examples 9 and 10, which, respectively, used 10 wt % and 15 wt % of 0.1Li₂MnO₃.0.9LiNi_{0.4}Co_{0.2}Mn_{0.4}O₂ turned out to show much lower exothermic heat (642 J/g, 983 J/g) compared to that(1102 J/g) of Comparative Example 7, which used only 2 wt % of 0.1Li₂MnO₃.0.9LiNi_{0.4}Co_{0.2}Mn_{0.4}O₂.

Likewise, Examples 1 and 2, which included excessive Ni, had remarkably low exothermic heat as compared to Comparative Examples 4 and 5. As such, the thermal stability of the positive active material may be improved by coating the core including excessive Ni with lithium iron phosphate.

In addition, the positive active material of Examples 3 to 7 coated with the shell including lithium iron phosphate had superior or similar 300 cycle capacity retention and capacity retention after being allowed to stand at a high temperature as compared to Comparative Examples 1 to 3, which did not include a shell according to embodiments of the invention; and Examples 1 and 2 also exhibited improved 300 cycle capacity retention and capacity retention after being allowed to stand at a high temperature as compared to Comparative Examples 4 and 5.

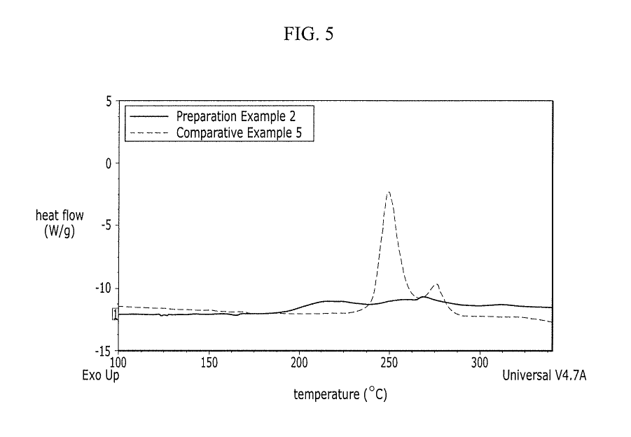

FIG. 4 to FIG. 6 show the resulting graphs from the DSC measurements.

As shown in FIG. 4 to FIG. 6, Preparation Examples 1 to 3 had remarkably lower exothermic heats than Comparative Preparation Examples 4, 5 and Comparative Preparation Example 1, respectively. From the results, it is understood that the positive active material having a core-shell structure according to embodiments of the invention had an excellent thermal stability.

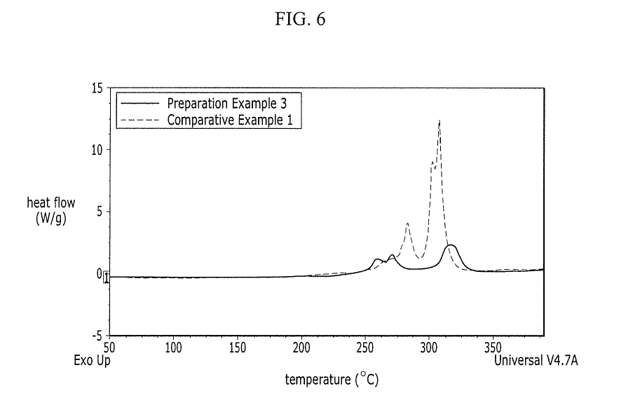

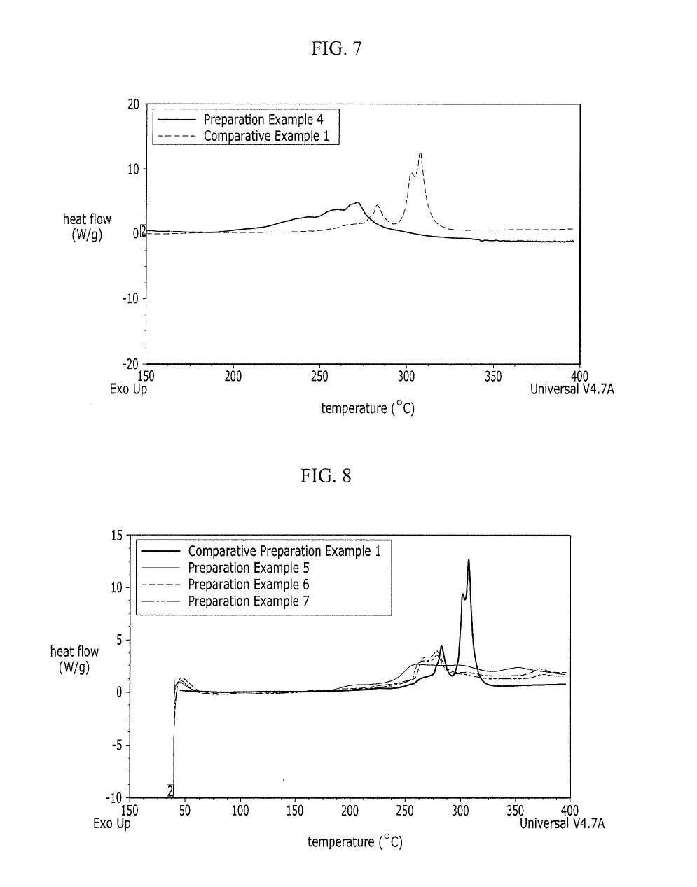

In addition, from FIGS. 7 and 8, it can be seen that Comparative Preparation Example 1 had a high peak at around 310° C.; Preparation Examples 4 to 7 had lower peaks of positive electrode decomposition and broad peaks at a higher temperature. From these results, it can be seen that the exothermic heat was remarkably decreased and the thermal stability was further improved when lithium iron phosphate was coated on the surface of lithium metal composite oxide together with a conductive material of a carbon-based material.

### (4) Thermal Stability Evaluation 2: Runaway Reaction Measurement

The battery cells obtained from Example 3 and Comparative Example 1 (18650 size, 1.3 Ah) were charged to 4.2 V SOC 100%, and the cell temperature change was monitored using ARC (accelerating rate calorimeter) while heating in the insulated state. ARC evaluation conditions are shown in the following Table 3.

TABLE 3

| | Predetermined or | |
|---|---|---|
| Setting parameter | preset value | |
| Start Temperature | 60° | C. |
| End Temperature | 450° | C. |
| Slope sensitivity | 0.02° | C./min |
| Heat step temperature | 5° | C. |
| Stabilization time after rising of | 15 | min |
| temperature | | |
| (Wait time) | | |
| Data step temperature | 1° | C. |
| Data step time | 0.5 | min |
| Calculation step temperature | 0.2° | C. |

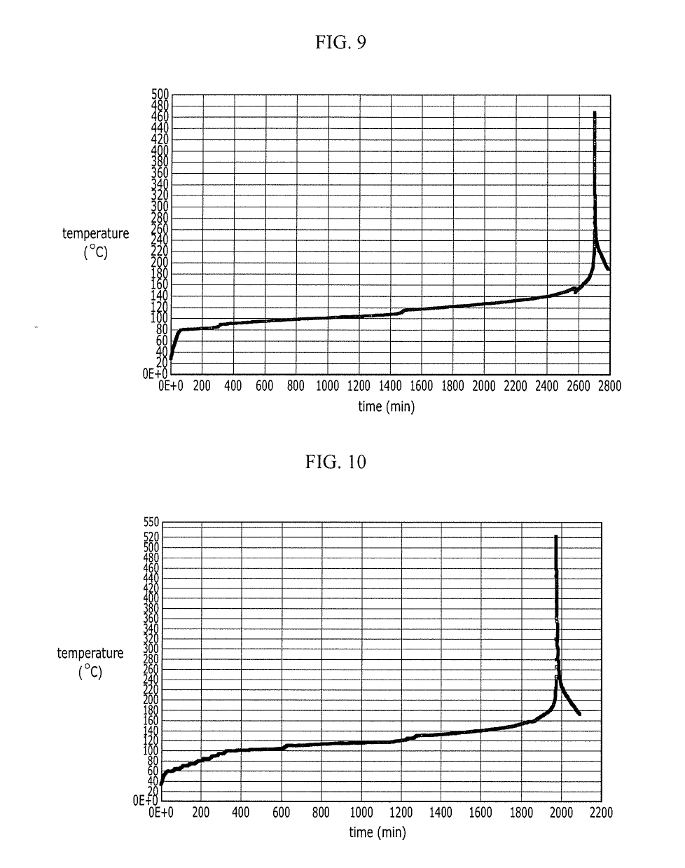

The ARC evaluation results are shown in the following Table 4, and FIG. 9 to FIG. 12 shows the temperature change graphs according to time.

As shown in the following Table 4, in Example 3, in which lithium iron phosphate was coated on the surface, the self heat rate was less than half of that of Comparative Example 1 and the exothermic time required to reach thermal runaway for Example 3 was more than twice that of Comparative Example 1. In addition, the generated exothermic heat (e.g., heat of reaction, J/g) of Example 3 was also low.

TABLE 4

| | Example 3 | Comparative Example 1 |
|---|---|---|
| cell weight (g) | 33.43 | 33.31 |
| Initial voltage (V) | 4.18 | 4.18 |
| Heat capacity (J/gK) | 0.951 | 0.945 |
| On-set temperature (T₀ ° C.) | 115.30 | 135.28 |
| Self heat rate at T0 (° C./min) | 0.020 | 0.044 |
| Final adiabatic temperature (° C.) | 468.40 | 581.54 |
| Adiabatic Temperature rise (° C.) | 353.10 | 446.26 |
| Exothermic heat (J/g) | 335.8 | 421.7 |
| (Heat of reaction) | | |
| Start time of thermal runaway | 1192.17 | 459.87 |
| (min) | | |
| (Exothermic time) | | |

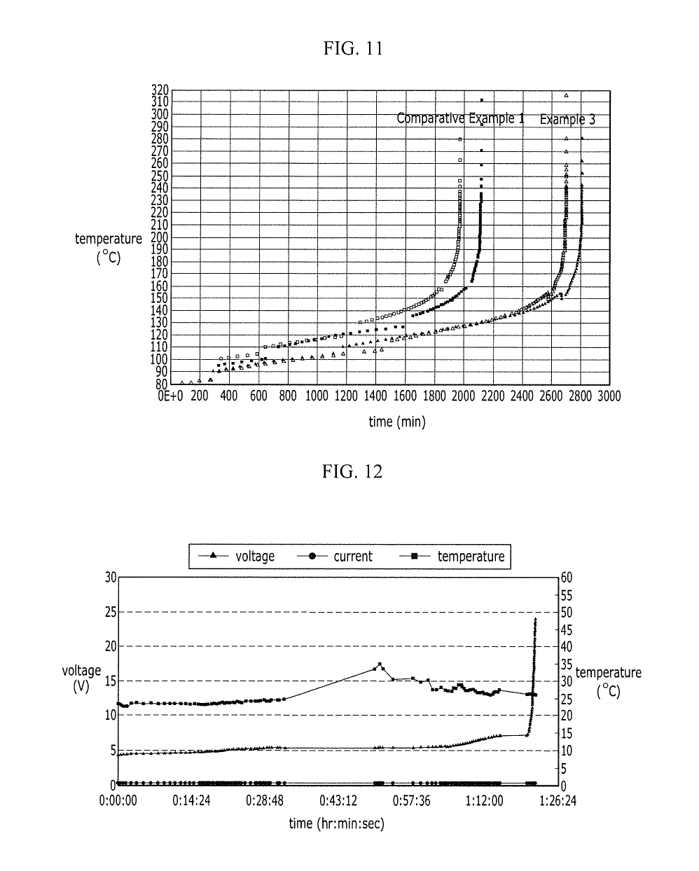

FIG. 9 and FIG. 10 shows the heat abuse evaluation results of rechargeable battery cells obtained from Example 3 and Comparative Example 1, respectively. Example 3 delayed the temperature increasing time as compared to Comparative Example 1. In addition, FIG. 11 shows a heat-wait-seek comparison graph in the insulation state, according to an ARC evaluation of Example 3 and Comparative Example 1, and it can be seen that the rechargeable lithium battery cell according to Example 3 delayed the speed of increasing the temperature, so resultantly, the time of reaching the highest temperature was prolonged. Accordingly, in one embodiment, lithium iron phosphate was coated on the surface of lithium metal composite oxide to suppress the generation of thermal runaway.

### (5) Thermal Stability Evaluation 3: Overcharge Evaluation

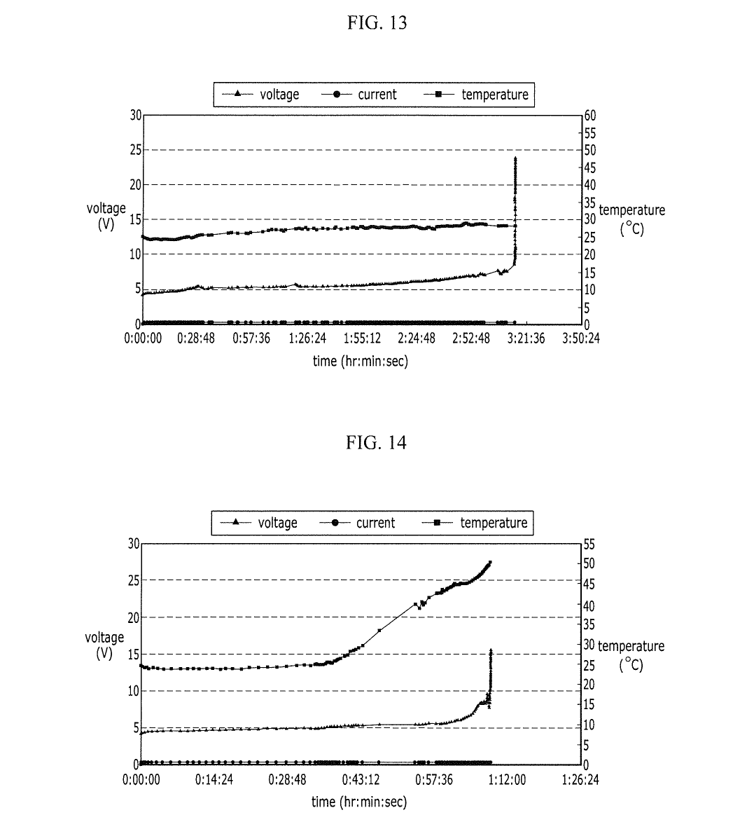

The battery cells according to Examples 3, 6 and Comparative Example 1 were performed with a 1 C-rate overcharge test, and the exothermic temperature was measured. The results are shown in FIGS. 12 to 14, respectively. Each voltage and temperature change was measured with the test conditions of charging the pouch cell attached with a temperature sensor on the cell surface at a 1 C-rate to 12 V. As shown in FIGS. 12 and 14, the maximum exothermic temperatures of Example 3 and Example 6 were about 35° C. and about 28° C., respectively; however, as shown in FIG. 14, the maximum exothermic temperature of Comparative Example 1 (which is not coated with a shell according an embodiment of the invention) was about 50° C., which was considerably higher as compared to Example 3 and Example 6. In addition, comparing the overcharged time, Comparative Example 1 exhibited a shorter overcharge time than Examples 3 and 6.

From the results, it is confirmed that the present invention provides excellent thermal stability.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A positive active material for a rechargeable lithium battery comprising:
a core comprising a lithium composite metal oxide selected from the group consisting of compounds represented by the following Chemical Formula 1, Chemical Formula 2, and combinations thereof,
LiₓMO₂ Chemical Formula 1
wherein, in Chemical Formula 1, M is one or more transition elements and 1≦x≦1.1,
yLi₂MnO₃·(1−y)LiM′O₂ Chemical Formula 2
wherein, in Chemical Formula 2, M′ is one or more transition elements and 0≦y≦1; and
a shell on the core, the shell comprising lithium iron phosphate (LiFePO₄), and the lithium iron phosphate being present in an amount in a range of about 5 to about 15 wt % based on the total weight of the positive active material.

2. The positive active material of claim 1, wherein M in Chemical Formula 1 and M′ in Chemical Formula 2 are each independently selected from the group consisting of NiₐCo_{b} (0≦a≦1, 0≦b≦1, a+b=1), CoₐMn_{b} (0<a<1, 0<b<1, a+b=1), NiₐMn_{b} (0<a<1, 0<b<1, a+b=1), NiₐCo_{b}Mn_{c} (0<a<1, 0<b<1, 0<c<1, a+b+c=1), NiₐCo_{b}Al_{c} (0<a<1, 0<b<1, 0<c<1, a+b+c=1), and combinations thereof.

3. The positive active material of claim 1, wherein the lithium composite metal oxide has an average particle diameter in a range of about 6 to about 20 μm, and the lithium iron phosphate has an average particle diameter in a range of about 0.2 to about 1 μm.

4. The positive active material of claim 1, wherein the lithium composite metal oxide is doped or coated with a metal oxide selected from the group consisting of ZrO₂, Al₂O₃, MgO, TiO₂, and combinations thereof.

5. The positive active material of claim 1, wherein the lithium composite metal oxide is doped with a metal oxide selected from the group consisting of ZrO₂, Al₂O₃, MgO, TiO₂, and combinations thereof.

6. The positive active material of claim 1, wherein the lithium composite metal oxide is coated with a metal oxide selected from the group consisting of ZrO₂, Al₂O₃, MgO, TiO₂, and combinations thereof, to form a second shell between the core and the shell.

7. The positive active material of claim 1, the shell further comprising a carbon-based material.

8. The positive active material of claim 7, wherein the carbon-based material is selected from the group consisting of activated carbon, carbon black, ketjen black, denka black, vapor grown carbon fiber (VGCF), carbon nanotubes, and combinations thereof.

9. The positive active material of claim 7, wherein the carbon-based material is present in an amount in a range of about 0.5 to about 5 wt % based on the total weight of the positive active material.

10. The positive active material of claim 1, wherein the lithium iron phosphate is present in the amount in the range of about 5 to about 10 wt % based on the total weight of the positive active material.

11. The positive active material of claim 1, wherein the core is present in an amount in a range of about 85 to about 95 wt % based on the total weight of the positive active material.

12. The positive active material of claim 1, wherein the core comprises the lithium composite metal oxide represented by Chemical Formula 1.

13. The positive active material of claim 12, wherein, in Chemical Formula 1, x=1.

14. The positive active material of claim 12, wherein, in Chemical Formula 1, x=1 and the lithium iron phosphate is present in the amount in the range of about 5 to about 10 wt % based on the total weight of the positive active material.

15. The positive active material of claim 12, wherein M in Chemical Formula 1 is NiₐCo_{b}Mn_{c} (0<a<1, 0<b<1, 0<c<1, a+b+c=1).

16. The positive active material of claim 15, wherein 0.5≦a≦0.8.

17. A rechargeable lithium battery comprising:
a positive electrode comprising a positive active material comprising:
a core comprising a lithium composite metal oxide selected from the group consisting of compounds represented by the following Chemical Formula 1, Chemical Formula 2, and combinations thereof,
LiₓMO₂ Chemical Formula 1
wherein, in Chemical Formula 1, M is one or more transition elements, and 1≦x≦1.1,
yLi₂MnO₃·(1−y)LiM′O₂ Chemical Formula 2
wherein, in Chemical Formula 2, M′ is one or more transition elements and 0≦y≦1; and
a shell on the core, the shell comprising lithium iron phosphate (LiFePO₄), and the lithium iron phosphate being present in an amount in a range of about 5 to about 15 wt % based on the total weight of the positive active material;
a negative electrode comprising a negative active material and facing the positive electrode; and
an electrolyte between the positive electrode and the negative electrode.

18. The rechargeable lithium battery of claim 17, wherein M in Chemical Formula 1 and M′ in Chemical Formula 2 are each independently selected from the group consisting of NiₐCo_{b} (0≦a≦1, 0≦b≦1, a+b=1), CoₐMn_{b} (0<a<1, 0<b<1, a+b=1), NiₐMn_{b} (0<a<1, 0<b<1, a+b=1), NiₐCo_{b}Mn_{c} (0<a<1, 0<b<1, 0<c<1, a+b+c=1), NiₐCo_{b}Al_{c} (0<a<1, 0<b<1, 0<c<1, a+b+c=1), and combinations thereof.

19. The rechargeable lithium battery of claim 17, wherein the negative active material comprises a material selected from the group consisting of materials for reversibly intercalating and deintercalating lithium ions, lithium metal, lithium metal alloys, materials for doping and dedoping lithium, transition metal oxides, and combinations thereof.

20. The rechargeable lithium battery of claim 17, wherein the electrolyte comprises phosphazenes or derivatives thereof in an amount in a range of about 5 to about 10 volume % based on the total volume of the electrolyte.
